(19) United States
(12) Patent Application Publication
(10) Pub. No.: US 2005/0058272 A1
(43) Pub. Date: Mar. 17, 2005

(54) Browsing method and apparatus for call record

(76) Inventor: Hsing-Wei Huang, Banqiao City (TW)

Correspondence Address: RABIN & Berdo, PC, 1101 14TH STREET, NW, SUITE 500, WASHINGTON, DC, 20005, US

(21) Appl. No.: 10/858,209

(22) Filed: Jun. 2, 2004

(30) Foreign Application Priority Data
Sep. 12, 2003 (TW) 92125161

(51) Int. Cl. H04M 3/00; H04M 1/00

(52) U.S. Cl. 379/355.02; 379/350

(57) ABSTRACT

A browsing method and apparatus for telephone call records. A call record is first obtained. It is determined whether an entry number of the call record corresponds to an entry number of an entry set. The entry name of the entry set is displayed on a display device if the entry number of the call record corresponds to the entry number of the entry set. Next, the key operation performed is identified, and, if corresponding to a predetermined operation, the entry number of the entry set is displayed on the display device.

### BACKGROUND OF THE INVENTION

1. Field of the Invention

The present invention relates to a browsing method and apparatus, and in particular to a browsing method and apparatus for telephone call records.

2. Description of the Related Art

Currently, cellular phones provide the ability to browse call records, such as dialed numbers, received call information, and unanswered call information for user convenience. Cellular phone displays are generally unable to display complete call register information, such as phone numbers, names, times, and others on a single display, because of the screen size and fundamental design, requiring detailed information of call records to be displayed any by added operations, causing inconvenience.

### SUMMARY OF THE INVENTION

Accordingly, an object of the present invention is to provide a browsing method, reducing operational steps and providing comprehensive information of call records in a single display of a cellular phone.

According to the object described, the present invention provides a method for browsing call records. First, directory record table, comprising at least one entry set, and a call record table are created. A call record, stored in the call record table is obtained and then call-record browsing is performed. Next, it is determined whether a key signaling a control command has been pressed. If so, it is then determined whether the pressed key is an up/down key, and, if so, an adjacent call record, prior or subsequent to the original record, and the arrival time thereof are displayed.

If not, it is then determined whether the pressed key is a left/right key, and, if so, it is then determined whether the currently selected call record has corresponding registry information in the directory record table. If so, the phone number and arrival time of the call record are displayed simultaneously. In addition, the name or other entry information, such as address and email, of the call record is then displayed in response to another left/right key entry.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a flowchart of the method for retrieving and displaying call record information according to the present invention;

FIG. 2 is a schematic diagram showing stored information in the present invention;

FIG. 3 is a flowchart of the method of displaying requested call record information and performing a retrieval operation according to the present invention;

FIG. 4 is a schematic diagram showing a call record list and status display of the present invention; and

FIG. 5 is a schematic diagram showing the architecture of the browsing apparatus of the present invention.

### DETAILED DESCRIPTION OF THE INVENTION

The present invention provides a method and apparatus for browsing call records.

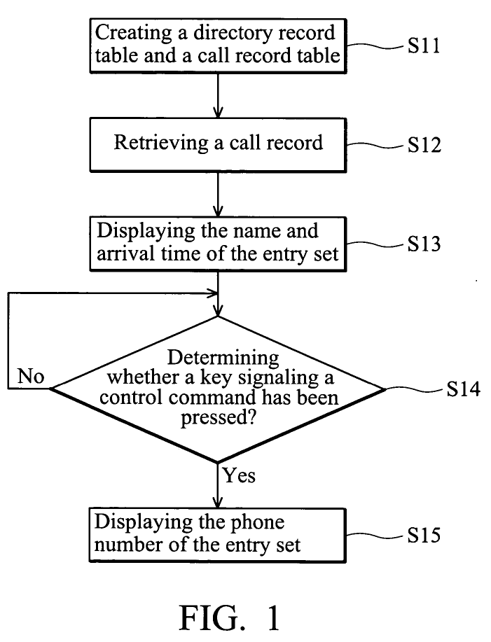

FIG. 1 is a flowchart of the method for retrieving and displaying call record information according to the present invention.

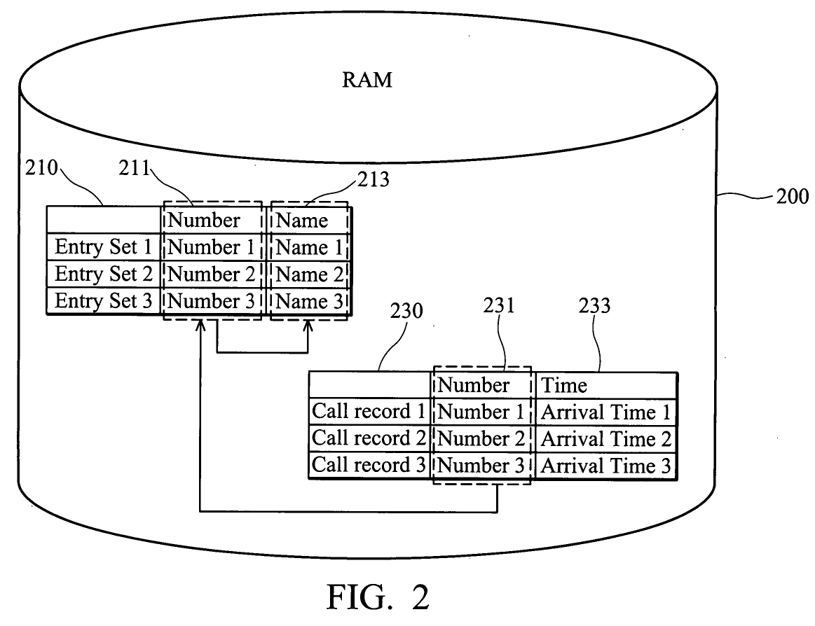

In step S11, a directory record table 210 and a call record table 230, as shown in FIG. 2, are created and stored in a random access memory (RAM) 200. Directory record table 210 comprises at least one number field 211 and name field 213, into which names and numbers are input for entry sets. Call record table 230 comprises at least one number field 231 and time field 233.

In step S12, a call record, comprising a dialed number, received call information, unanswered call information or other, is obtained and stored in call record table 230.

In step S13, the obtained call record is compared with entry sets in directory record table 210. If a match is found, the name and arrival time of the entry set are displayed.

In step S14, it is determined whether a key signaling a control command has been pressed, and, if so, the process goes to step S15. If not, step S14 is repeated.

In step S15, the phone number of the entry set is displayed.

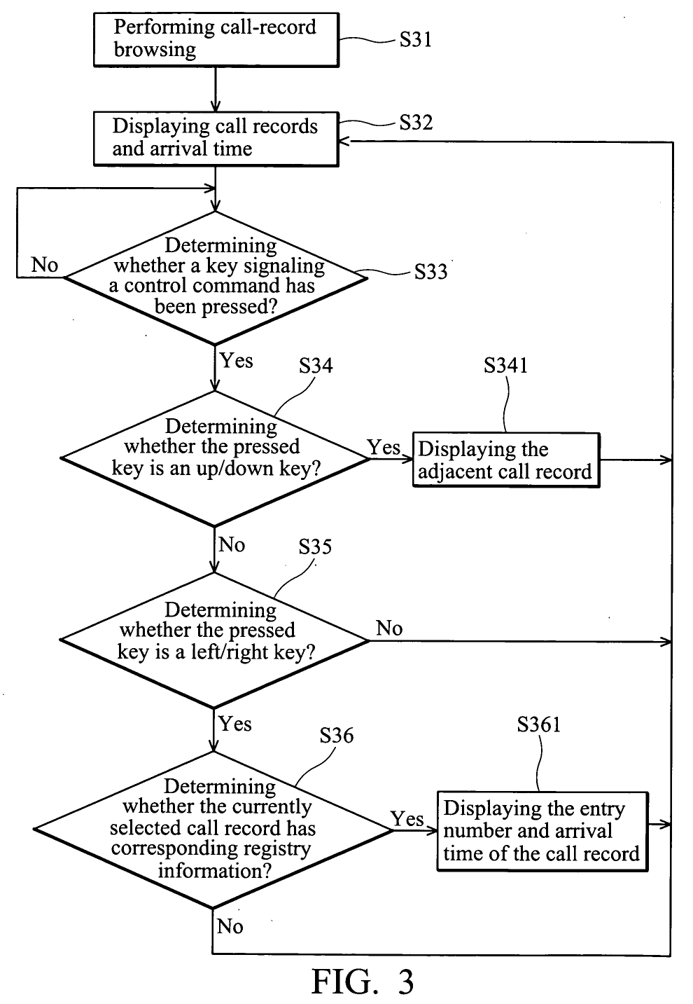

FIG. 3 is a flowchart of the method of displaying requested call record information and performing a retrieval operation according to the present invention.

In step S31, call records comprising dialed numbers, received call information, and unanswered call information are browsed.

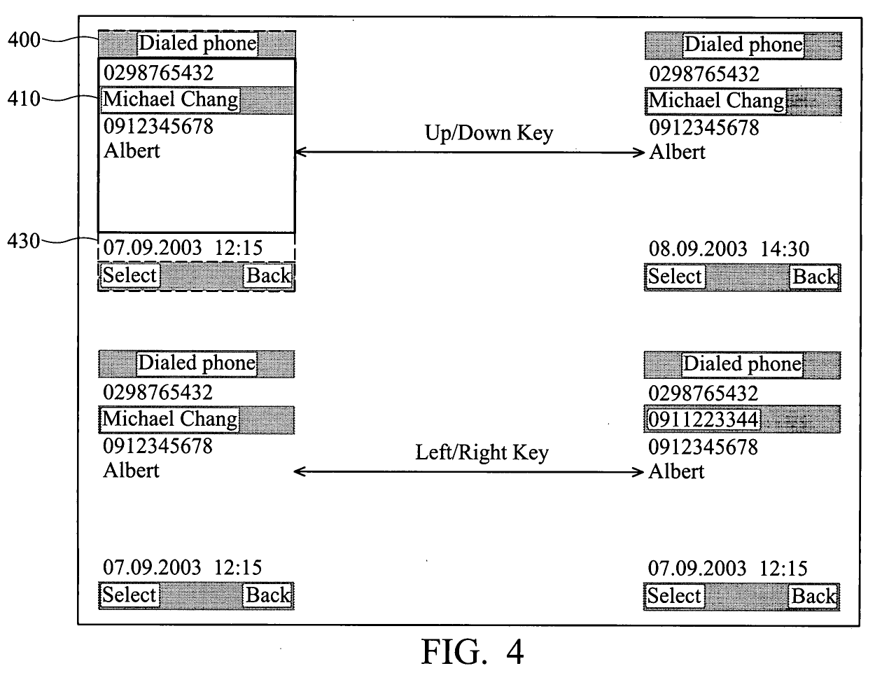

In step S32, call records are displayed in call record list 410 in call record window 400, with arrival time displayed in status bar 430, as shown in FIG. 4.

In step S33, it is determined whether a key signaling a control command has been pressed, and, if so, the process goes to step S34. If not, step S33 is repeated.

In step S34, it is determined whether the pressed key is an up/down key, and, if so, the process goes to step S341, and, if not, to step S35.

In step S341, an adjacent call record, prior or subsequent to the original record, and the arrival time thereof are displayed, as shown in FIG. 4, and the process then goes to step S32.

In step S35, it is determined whether the pressed key is a left/right key, and, if so, the process goes to step S36, and, if not, to step S32.

In step S36, it is determined whether the currently selected call record has corresponding registry information in directory record table 210. Call records are stored in call record table 230, as shown in FIG. 2, and, when a call record is retrieved, the phone number thereof is compared with the numbers stored in directory record table 210, determining whether the phone number has been registered in directory record table 210. At the outset of browsing, default display comprises the name of a call record, with corresponding entry set in directory record table 210, or the phone number of the call record is displayed without registration. Thus, in this step, the process goes to step S361 if the phone number of the call record is registered in directory record table 210. If not, the process goes to step S32, for continuation, without any operation.

In step S361, the phone number and arrival time of the call record are displayed simultaneously. In addition, the name or other entry information, such as address and email, of the call record is then displayed in response to another left/right key entry.

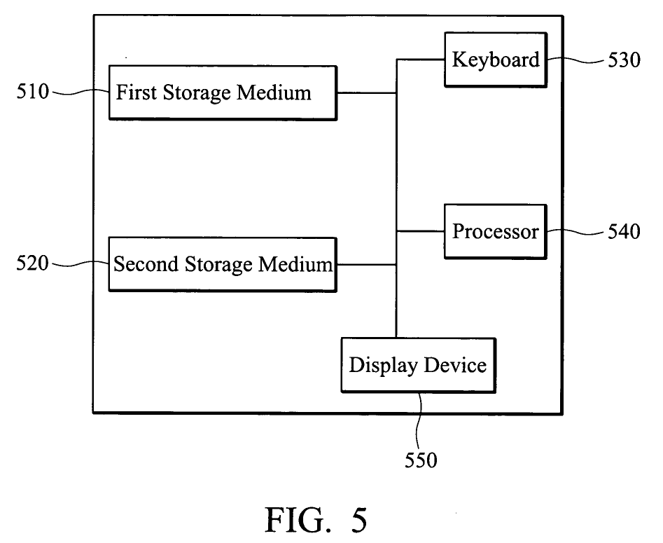

FIG. 5 is a schematic diagram showing the architecture of the browsing apparatus of the present invention.

The architecture comprises a first storage medium 510, such as random access memory, storing a directory record table, comprising at least one entry set, and a call record table, comprising at least one call record. A second storage medium 520, such as flash memories, stores program codes of a browsing method for telephone call records. A display device 550 comprises call record window 400 shown in FIG. 4.

A processor 540 determines whether a key signaling a control command has been pressed using a keyboard 530, and, if so, determines whether the pressed key is an up/down key. Next, if the pressed key is the up/down key, an adjacent call record, prior or subsequent to the original record, and the arrival time thereof are displayed, and, if not, processor 540 determines whether the pressed key is a left/right key

If the pressed key is the left/right key, processor 540 then determines whether the currently selected call record has corresponding registry information in the directory record table. If the phone number of the call record is registered in the directory record table, the phone number and arrival time of the call record are displayed simultaneously. In addition, the name or other entry information, such as address and email, of the call record is then displayed in response to another left/right key entry.

The invention provides comprehensive information of call records in a single display of a cellular phone without added operations impacting user convenience.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A method for browsing call records, comprising the steps of:
obtaining a call record;
when first call information of the call record corresponds to first entry information of an entry set, displaying second entry information of the entry set;
identifying the key operation performed; and
displaying the first entry information of the entry set if a predetermined key operation is performed.

2. The method as claimed in claim 1, wherein the display of the first entry information further displays the arrival time of the call record.

3. The method as claimed in claim 1, wherein the call record is a dialed number, received call information, or unanswered call information.

4. A method for browsing call records, comprising the steps of:
providing a directory record table, comprising at least one entry set, and a call record table, wherein the entry set comprises at least one entry name and entry number;
obtaining a call record, stored in the call record table, wherein the call record comprises at least one entry number;
determining whether the entry number of the call record corresponds to the entry umber of the entry set;
displaying the entry name of the entry set on a display device if the entry number of the call record corresponds to the entry number of the entry set;
identifying the key operation performed; and
displaying the first entry information of the entry set if a predetermined key operation is performed.

5. The method as claimed in claim 4, wherein the entry number display of the entry set further displays the arrival time of the call record.

6. The method as claimed in claim 4, wherein the call record is a dialed number, received call information, or unanswered call information.

7. An apparatus for browsing call records, comprising:
a first storage medium, storing a directory record table, comprising at least one entry set, and a call record table, comprising at least one call record;
a second storage medium, coupled to the first storage medium, storing program codes for a browsing method for telephone call records;
a display device, coupled to the first storage medium and the second storage medium, displaying call information of the call record; and
a processor, coupled to the first storage medium, the second storage medium, and the display device, performing call-record browsing through the program codes, determining whether an entry number of the call record corresponds to an entry number of the entry set, displaying the entry name of the entry set on a display device if the entry number of the call record corresponds to the entry number of the entry set, identifying the key operation performed, and displaying the first entry information of the entry set if a predetermined key operation is performed.

8. The apparatus as claimed in claim 7, wherein the entry number display of the entry set further displays the arrival time of the call record.

9. The apparatus as claimed in claim 7, wherein the call record is a dialed number, received call information, or unanswered call information.
